(19) United States
(12) Patent Application Publication
(10) Pub. No.: US 2006/0235936 A1
(43) Pub. Date: Oct. 19, 2006

(54) System and method for PACS workstation conferencing

(75) Inventors: Weng I. Lei, Mt. Prospect, IL (US); Kengo Baba, Evanston, IL (US); Murali Kumaran Kariathungal, Hoffman Estates, IL (US); James Edward Jay, Lake Villa, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/107,648

(22) Filed: Apr. 15, 2005

(51) Int. Cl. G06F 15/16

(52) U.S. Cl. 709/208

(57) ABSTRACT

Certain embodiments of the present invention provide an improved medical imaging and information management system and method with conferencing and control capability. Certain embodiments of the system include an initiator workstation capable of remotely controlling functionality at a slave workstation and a slave workstation including functionality capable of control by the initiator workstation. The initiator workstation is capable of remotely configuring a display protocol of said slave workstation to share diagnostic quality images. In an embodiment, the system includes a picture archiving and communication system (PACS), with first and second PACS workstations as the initiator and slave workstations, for example. In an embodiment, the initiator controls all functionality at the slave. In an embodiment, the initiator controls selected functions at the slave. The initiator workstation may display at least one diagnostic quality image on a display at said slave workstation independent of image quality of said display, for example.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to an image and information management system. In particular, the present invention relates to an image and information management system with remote conferencing and collaboration capability.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

In a healthcare or clinical environment, such as a hospital, a large number of employees and patients may result in confusion or delay when trying to reach other medical personnel for examination, treatment, consultation, or referral, for example. A delay in contacting other medical personnel may result in further injury or death to a patient. Additionally, a variety of distractions in a clinical environment may frequently interrupt medical personnel or interfere with their job performance. Furthermore, workspaces, such as a radiology workspace, may become cluttered with a variety of monitors, data input devices, data storage devices, and communication devices, for example. Cluttered workspaces may result in inefficient workflow and service to clients, which may impact a patient's health and safety or result in liability for a healthcare facility.

Data entry and access is also complicated in a typical healthcare facility. Speech transcription or dictation is typically accomplished by typing on a keyboard, dialing a transcription service, using a microphone, using a Dictaphone, or using digital speech recognition software at a personal computer. Such dictation methods involve a healthcare practitioner sitting in front of a computer or using a telephone, which may be impractical during operational situations. Similarly, for access to electronic mail or voice messages, a practitioner must typically use a computer or telephone in the facility. Access outside of the facility or away from a computer or telephone is limited.

Thus, management of multiple and disparate devices, positioned within an already crowded environment, that are used to perform daily tasks is difficult for medical or healthcare personnel. Additionally, a lack of interoperability between the devices increases delay and inconvenience associated with the use of multiple devices in a healthcare workflow. The use of multiple devices may also involve managing multiple logons within the same environment. A system and method for improving ease of use and interoperability between multiple devices in a healthcare environment would be highly desirable.

Healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided among a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Imaging systems are complicated to configure and to operate. Often, healthcare personnel may be trying to obtain an image of a patient, reference or update patient records or diagnosis, and/or ordering additional tests or consultation, for example. Thus, there is a need for a system and method that facilitate operation and interoperability of an imaging system and related devices by an operator.

Additionally, in a healthcare workflow, healthcare providers often consult or otherwise interact with each other. Such interaction typically involves paging or telephoning another practitioner. Thus, interaction between healthcare practitioners may be time- and energy-consuming. Therefore, there is a need for a system and method to simplify and improve communication and interaction between healthcare practitioners.

Furthermore, healthcare practitioners may want or need to review diagnoses and/or reports from another healthcare practitioner. For example, a referring physician may want to review a radiologist's diagnosis and report with the radiologist and/or a technician. As another example, an emergency room physician may need to review results of an emergency room study with the radiologist and/or a family physician. Thus, there is a need for a system and method for notifying or informing appropriate parties of results in order to collaborate for diagnosis and/or treatment review for safe and effective treatment.

Typically, healthcare practitioners determine each other's availability and schedule a collaboration event. Thus, current systems and methods require more manual involvement and multiple steps. Current systems encouraging interactions between healthcare practitioners consist of several discrete or manual actions involving a number of disparate systems and/or individuals. First, third parties are notified of information availability. Then, third parties obtain the information by accessing one or more systems. After a system verifies that the information has been received, the practitioner and third party must determine their availability for collaboration. After the parties schedule a mutually available time for collaboration, the parties may finally collaborate to review exam results, diagnosis, treatment, etc. The involvement of a plurality of disparate systems/parties and requirement of several disparate steps renders current systems and methods complicated, inefficient, and time consuming. An ability to reduce the number of actions required by interested parties, reduce the number of ineffective actions, and reduce the waiting time required to obtain necessary information and perform a collaboration would result in more efficient and effective healthcare delivery.

Healthcare experts are located around the world and are often separated by large distances. Collaboration between experts and other healthcare practitioners is often difficult to coordinate. Additionally, current collaboration systems and efforts do not allow efficient sharing of information, including diagnostic images, between healthcare practitioners. Current communication systems only allow basic textual communication, rather than detail interaction and collaboration between parties. Current systems are limited in their ability to display diagnostic quality images.

Thus, there is a need for a system and method for improved collaboration and control in a healthcare environment.

### BRIEF SUMMARY OF THE INVENTION

Certain embodiments of the present invention provide an improved medical imaging and information management system and method with conferencing and control capability. Certain embodiments of the system include an initiator workstation capable of remotely controlling functionality at a slave workstation and a slave workstation including functionality capable of control by the initiator workstation. The initiator workstation is capable of remotely configuring a display protocol of said slave workstation to share diagnostic quality images. In an embodiment, the system includes a picture archiving and communication system (PACS), with first and second PACS workstations as the initiator and slave workstations, for example.

In an embodiment, the initiator workstation controls all functionality at the slave workstation. In an embodiment, the initiator workstation controls selected functions at the slave workstation. The initiator workstation may display at least one diagnostic quality image on a display at said slave workstation independent of image quality of said display, for example. In an embodiment, the initiator workstation is capable of controlling functionality at said slave workstation in real time. The initiator workstation may be capable of controlling functionality at the slave workstation using voice command, for example.

In an embodiment, the system includes an authentication module for authenticating access by at least one user to at least one of said initiator workstation and said slave workstation. The initiator workstation may share a medical study, a report, a diagnostic image, an image annotation, a region of interest in an image, audio, and/or video, for example, with said slave workstation. The initiator workstation may control diagnostic image display, display protocol configuration, report creation, report modification, image annotation, and/or dictation, for example, at said slave workstation.

Certain embodiments of a method for remote control of an image and information management system workstation include requesting a conference with an image and information management system workstation, determining acceptance of said conference request at said image and information management system workstation, and remotely controlling at least a portion of functionality at said image and information management system workstation without regard to diagnostic image display protocol used at said image and information management system workstation. The method may include remotely controlling selected functions at the image and information management system workstation. In an embodiment, the selected functions are selected by a user at the image and information management system workstation. The method may also include remotely controlling all functionality at the image and information management system workstation.

In an embodiment, the method further includes determining acceptance of said conference request at said image and information management system workstation based on querying a user at said image and information management system workstation. The method may also include terminating said remote control of at least a portion of functionality at said image and information management system workstation. Additionally, the method may include authenticating access to said image and information management system workstation for remote control of said image and information management system workstation.

Certain embodiments include a computer-readable storage medium including a set of instructions for a computer. The set of instructions includes a control initiator routine for initiating a conference request with a workstation, a response routine for at least one of accepting and denying the conference request, and a remote control routine for remotely controlling functionality of the workstation after acceptance of the conference request. The remote control routine accommodates a display protocol at the workstation. In an embodiment, the remote control routine transmits at least one of an image and information for display at the workstation. The remote control routine may be capable of remotely configuring a display protocol of the workstation to share diagnostic quality images, for example.

### BRIEF DESCRIPTION OF SEVERAL VIEWS OF THE DRAWINGS

FIG. 1 illustrates an exemplary Picture Archiving and Communication System (PACS) system in accordance with an embodiment of the present invention.

FIG. 2 illustrates an image management and communication system used in accordance with an embodiment of the present invention.

FIG. 3 depicts a flow diagram for a method for workstation conferencing used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

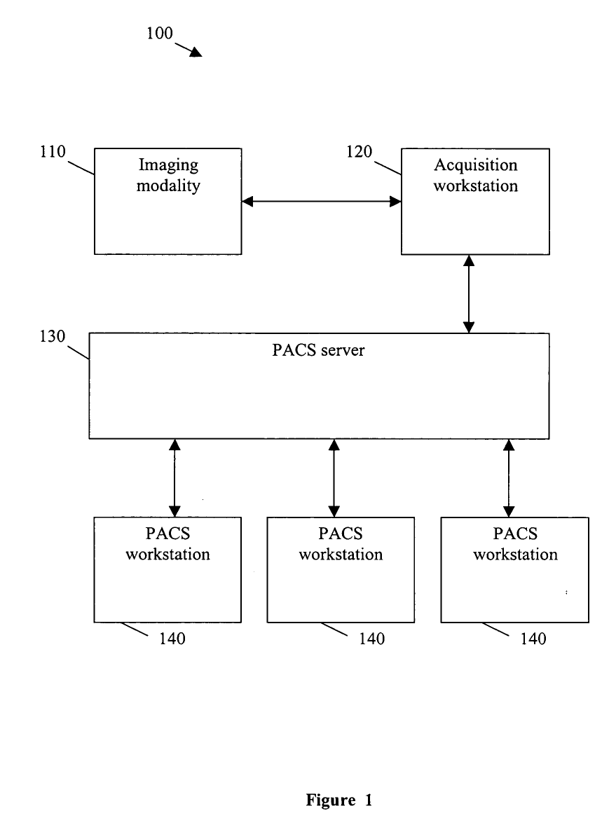

FIG. 1 illustrates an exemplary Picture Archiving and Communication System (PACS) system 100 in accordance with an embodiment of the present invention. The PACS system 100 includes an imaging modality 110, an acquisition workstation 120, a network server 130, and one or more display workstations 140. The system 100 may include any number of imaging modalities 110, acquisition workstations 120, network servers 130 and display workstations 140 and is not in any way limited to the embodiment of system 100 illustrated in FIG. 1.

In operation, the imaging modality 110 obtains one or more images of a patient anatomy. The imaging modality 110 may include any device capable of capturing an image of a patient anatomy such as a medical diagnostic imaging device. For example, the imaging modality 110 may include an X-ray imager, ultrasound scanner, magnetic resonance imager, or the like. Image data representative of the image(s) is communicated between the imaging modality 110 and the acquisition workstation 120. The image data may be communicated electronically over a wired or wireless connection, for example.

In an embodiment, the acquisition workstation 120 may apply one or more preprocessing functions to the image data in order to prepare the image for viewing on a display workstation 140. For example, the acquisition workstation 120 may convert raw image data into a DICOM standard format or attach a DICOM header. Preprocessing functions may be characterized as modality-specific enhancements, for example (e.g., contrast or frequency compensation functions specific to a particular X-ray imaging device), applied at the beginning of an imaging and display workflow. The preprocessing functions may differ from processing functions applied to image data in that the processing functions are not modality specific and are instead applied at the end of the imaging and display workflow (for example, at a display workstation 140).

The image data may then be communicated between the acquisition workstation 120 and the network server 130. The image data may be communicated electronically over a wired or wireless connection, for example.

The network server 130 may include computer-readable storage media suitable for storing the image data for later retrieval and viewing at a display workstation 140. The network server 130 may also include one or more software applications for additional processing and/or preprocessing of the image data by one or more display workstations 140, for example.

One or more display workstations 140 are capable of or configured to communicate with the server 130. The display workstations 140 may include a general purpose processing circuit, a network server 130 interface, a software memory, and/or an image display monitor, for example. The network server 130 interface may be implemented as a network card connecting to a TCP/IP based network, but may also be implemented as a parallel port interface, for example.

The display workstations 140 may retrieve or receive image data from the server 130 for display to one or more users. For example, a display workstation 140 may retrieve or receive image data representative of a computed radiography (CR) image of a patient's chest. A radiologist may then examine the image for any objects of interest such as tumors, lesions, etc.

The display workstations 140 may also be capable of or configured to apply processing functions to image data. For example, a user may desire to apply processing functions to enhance features within an image representative of the image data. Processing functions may therefore adjust an image of a patient anatomy in order to ease a user's diagnosis of the image. Such processing functions may include any software-based application that may alter a visual appearance or representation of image data. For example, a processing function can include any one or more of flipping an image, zooming in an image, panning across an image, altering a window and/or level in a grayscale representation of the image data, and altering a contrast and/or brightness an image.

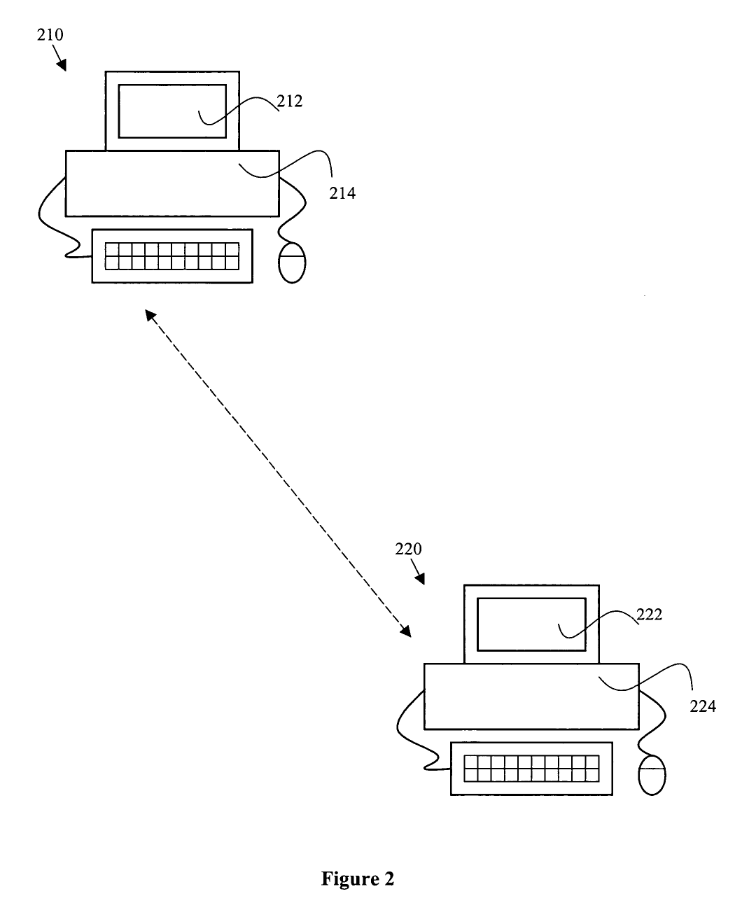

FIG. 2 illustrates an image and information management system 200 used in accordance with an embodiment of the present invention. The image and information management system 200 includes a plurality of workstations 210, 220. In an embodiment, the image and information management system 200 is a picture archiving and communication system (PACS) including a plurality of PACS workstations. The image and information management system 200 may be a PACS system similar to the PACS system 100 described above in relation to FIG. 1.

The image and information management system 200 is capable of performing image management, image archiving, exam reading, exam workflow, and/or other medical enterprise workflow tasks, for example. In an embodiment, the system 200 is or includes a PACS, for example. The system 200 may also include a healthcare or hospital information system (HIS), a radiology information system (RIS), a clinical information system (CIS), a cardiovascular information system (CVIS), a library information system (LIS), order processing system, and/or an electronic medical record (EMR) system, for example. The image management system 200 may include additional components such as an image manager for image management and workflow and/or an image archive for image storage and retrieval.

The image and information management system 200 may interact with one or more modalities, such as an x-ray system, computed tomography (CT) system, magnetic resonance (MR) system, ultrasound system, digital radiography (DR) system, positron emission tomography (PET) system, single photon emission computed tomography (SPECT) system, nuclear imaging system, and/or other modality. The image and information management system 200 may acquire image data and related data from the modality for processing and/or storage.

In an embodiment, one of the workstations 210 may function as an initiator workstation and another of the workstations 220 may function as a slave workstation. The initiator workstation 210 initiates a request to take control of the slave workstation 220. The slave workstation 220 accepts a request for control and allows the initiator workstation 210 to control some or all functionality of the slave workstation 220. In an embodiment, any workstation in the system 200 may serve as an initiator and/or a slave with respect to another workstation.

The initiator workstation 210 may be used to display content and/or activity from the initiator workstation 210 at the slave workstation 220, for example. For example, studies, reports, images, annotations, regions of interest, audio, video, text, and/or other information may be displayed at the slave workstation 220 at the instruction of the initiator workstation 210. Thus, a healthcare practitioner, such as a radiologist, may view content at the slave workstation 220 displayed by the initiator workstation 210. Information from the initiator workstation 210 may be displayed in near real-time at the slave workstation 220. Conferencing features of the system 200 help improve resident workflow, expert consultation, and/or teaching hospitals, for example.

In an embodiment, connection and collaboration between the initiator workstation 210 and the slave workstation 220 occur regardless of display resolution (low resolution display, high resolution display, etc.) at the workstations 210, 220. For example, diagnostic images may be displayed at the initiator workstation 210 and/or slave workstation 220 without regard to display resolution. Software and/or hardware running on the initiator workstation 210 and/or the slave workstation 220 accommodate for differences in display resolution and help to ensure that a diagnostic quality image is displayed. Furthermore, in an embodiment, connection and collaboration between the initiator workstation 210 and the slave workstation 220 occur independent of a number of displays connected to each workstation 210, 220. For example, the system 200 may resolve display of information between an initiator workstation 210 with one or more displays and a slave workstation 220 with one or more displays.

In an embodiment, the initiator workstation 210 includes an interface 212 capable of allowing control of and exchange of information with the slave workstation 220. The interface 212 may be a graphical user interface (GUI) or other user interface that may be configured to allow a user to access functionality at the initiator workstation 210 and/or the slave workstation 220. The slave workstation 220 may also include an interface 222 that may be configured to allow a user to access functionality at the slave workstation 220. The interfaces 212, 222 may be connected to an input device, such as a keyboard, mousing device, and/or other input device, for example.

Additionally, the initiator workstation 210 and the slave workstation 220 may include communication devices 214 and 224, respectively, to allow communication between the initiator workstation 210 and the slave workstation 220. The communication devices 214, 224 may include a modem, wireless modem, cable modem, Bluetooth™ wireless device, infrared communication device, wired communication device, and/or other communication device, for example. The communication devices 214, 224 communicate and transfer data via one or more communication protocols, such as the DICOM protocol. The communication devices 214, 224 coordinate with processors in the workstations 210, 220 to establish a connection between the workstations 210, 220 and remotely execute functionality and/or transfer data, for example.

In an embodiment, the initiator workstation 210 may interface with and/or control the slave workstation 220 according to one or more rules and/or preferences. A password and/or other authentication, such as voice or other biometric authentication, may be used to establish a connection between the initiator workstation 210 and the slave workstation 220.

In an embodiment, users at the workstations 210, 220 may communicate via telephone, electronic “chat” or messaging, Voice over Internet Protocol (VoIP) communication, or other communication via the workstations 210, 220 and/or separate from the workstations 210, 220. Users at the initiator 210 and slave 220 workstations may share display protocols, perspectives, rules, information, etc.

In an embodiment, one or more initiator workstations 210 may communicate with one or more slave workstations 220. The initiator workstation 210 or other component of the system 200 may store profile(s) and/or other connection information for one or more slave workstations 220 or users. In an embodiment, interaction between the initiator workstation 210 and the slave workstation 220 is manually initiated. In an embodiment, interaction between the initiator workstation 210 and the slave workstation 220 may be scheduled based on calendar or availability information, user preference, rules, and/or other criteria, for example. In an embodiment, the slave workstation 220 is automatically detected by the initiator workstation 210. In an embodiment, a certain type of initiator workstation 210, such as a PACS workstation, may communicate with and control a different type of slave workstation 220, such as a HIS, RIS, CIS, CVIS, LIS, or EMR workstation.

In an embodiment, actions that may be controlled by the initiator 210 may be defined as super initiator actions and specialized initiator actions. Super initiation allows control of all functionality at the slave workstation, such as image display, default display protocol (DDP) configuration, report creation/modification, dictation, etc. Specialized initiation allows control of selected functions specified by the slave workstation 220. In an embodiment, functions may be selected at the slave workstation 220 during a response by the slave workstation 220 to a control request from the initiator workstation 210. The slave workstation 220 may specify whether control may be taken as super initiator control or specialized initiator control, for example. If control is specialized user control, the slave workstation 220 selects functions and/or sets of functions that the initiator 210 is allowed to control.

For example, the initiator workstation 210 may be selectively authorized by the slave workstation 220 to display images and adjust display configuration parameters. The initiator workstation 210 may be selectively authorized to control reporting functionality at the slave workstation 220, for example. Alternatively, the initiator workstation 210 may have complete control of the functionality of the slave workstation 210 including image acquisition, image display, image processing, reporting, etc.

In an embodiment, a healthcare practitioner may use the initiator workstation 210 to perform a variety of functions at the slave workstation 220 for another healthcare practitioner. For example, a radiologist may indicate findings within image data at the slave workstation 220 via the initiator workstation 210 for a physician. A healthcare practitioner may also convey and/or identify diagnosis information, treatment information, and/or consultation or referral information, for example. For example, a surgeon may consult a specialist in real-time during surgery and allow the specialist to view and comment on images and/or data from the operation in progress. In an embodiment, a healthcare practitioner may dictate and/or annotate an image or report on the slave workstation 220 via the initiator workstation 210. In an embodiment, functions at the slave workstation 220 may be controlled via voice command at the initiator workstation 210.

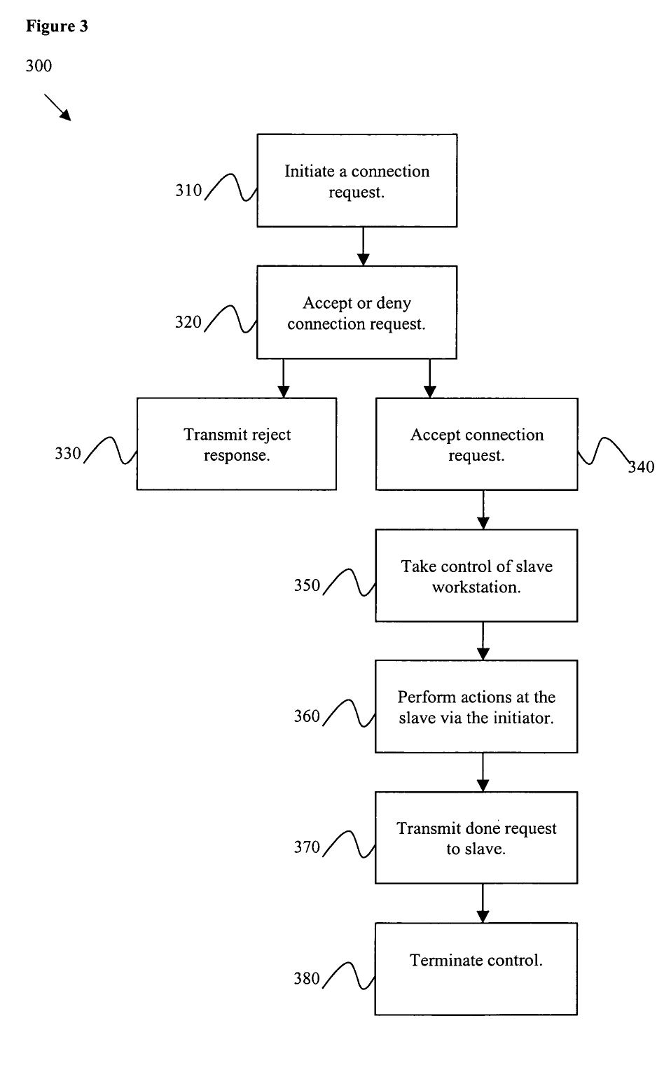

FIG. 3 depicts a flow diagram for a method 300 for workstation conferencing used in accordance with an embodiment of the present invention. First, at step 310, a healthcare practitioner initiates a request for connection to a slave workstation. For example, a radiologist initiates a request to perform Centricity PACS workstation conferencing on a second workstation. Next, at step 320, a healthcare practitioner at the slave workstation determines whether to accept or deny the connection request. For example, a radiologist at the second workstation decides whether to accept or deny the request from the Centricity PACS workstation.

Then, at step 330, if the connection request is denied, the slave workstation transmits a reject response, and the request is aborted. In an embodiment, a second slave workstation may then be queried, and/or the connection request may be rescheduled for a later attempt. At step 340, the connection request is accepted.

Then, at step 350, the initiator takes control of the slave workstation. In an embodiment, the initiator workstation controls all or a subset of functionality and data at the slave workstation. An extent of control by the initiator may be defined by user selection, rules, preferences, and/or other parameters, for example. Next, at step 360, allowed actions are performed on the slave workstation via the initiator workstation. For example, the radiologist using the initiator workstation displays and annotates examination results on the slave workstation.

At step 370, a done request is transmitted to the slave workstation. For example, after a conference has concluded, the initiator workstation transmits a done request or end of conference message to the slave workstation. Then, at step 380, control is terminated. For example, the connection established between the initiator workstation and the slave workstation may be ended. In an embodiment, control of the slave workstation is relinquished by the initiator workstation while the connection between the slave workstation and the initiator workstation is maintained.

Thus, certain embodiments provide healthcare practitioners, such as radiologists and residents, with an ability to conference and collaborate remotely. Certain embodiments improve resident workflow by allowing residents to consult in real-time or substantially real-time with senior physicians or specialists. Certain embodiments allow healthcare practitioners to consult with experts in a given field and receive a rapid response from experts around the world. In teaching hospitals or other training or learning environments, education and training may be facilitated by sharing patient data and images with faculty, students, and other healthcare practitioners in a non-classroom environment. Certain embodiments allow peers to share patient information and images for real-time or substantially real-time reading and analysis. Additionally, certain embodiments allow practitioners to conference and share diagnostic quality images.

Certain embodiments allow a user at a workstation, such as a PACS workstation, to take control of another system to display images, create/modify reports, configure a display protocol, and/or execute other functions or share other data at another workstation. Certain embodiments allow collaboration and conferencing between workstations independent of a number of monitors on a workstation. Certain embodiments allow collaboration and conferencing independent of monitor resolutions and/or display protocols. Certain embodiments allow sharing of diagnostic quality images. Additionally, certain embodiments allow real-time or substantially real-time sharing of peer workstation activities.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An improved medical image and information management system with conferencing capability, said system comprising:
an initiator workstation capable of remotely controlling functionality at a slave workstation; and
a slave workstation including functionality capable of control by the initiator workstation,
wherein said initiator workstation is capable of remotely configuring a display protocol of said slave workstation to share diagnostic quality images.

2. The system of claim 1, wherein said initiator workstation controls all functionality at the slave workstation.

3. The system of claim 1, wherein said initiator workstation controls selected functions at the slave workstation.

4. The system of claim 1, wherein said system comprises a picture archiving and communication system (PACS), and wherein said initiator workstation and said slave workstation comprise first and second PACS workstations.

5. The system of claim 1, wherein said initiator workstation displays at least one diagnostic quality image on a display at said slave workstation independent of image quality of said display.

6. The system of claim 1, wherein said initiator workstation is capable of controlling functionality at said slave workstation in real time.

7. The system of claim 1, wherein said initiator workstation is capable of controlling functionality at said slave workstation using voice command.

8. The system of claim 1, further comprising an authentication module for authenticating access by at least one user to at least one of said initiator workstation and said slave workstation.

9. The system of claim 1, wherein said initiator workstation shares at least one of a medical study, a report, a diagnostic image, an image annotation, a region of interest in an image, audio, and video with said slave workstation.

10. The system of claim 1, wherein said initiator workstation controls at least one of diagnostic image display, display protocol configuration, report creation, report modification, image annotation, and dictation at said slave workstation.

11. A method for remote control of an image and information management system workstation, said method comprising:
requesting a conference with an image and information management system workstation;
determining acceptance of said conference request at said image and information management system workstation; and
remotely controlling at least a portion of functionality at said image and information management system workstation without regard to diagnostic image display protocol used at said image and information management system workstation.

12. The method of claim 11, wherein said remotely controlling step further comprises remotely controlling selected functions at said image and information management system workstation.

13. The method of claim 12, wherein said selected functions are selected by a user at said image and information management system workstation.

14. The method of claim 11, wherein said remotely controlling step further comprises remotely controlling all functionality at said image and information management system workstation.

15. The method of claim 11, wherein said determining step further comprises determining acceptance of said conference request at said image and information management system workstation based on querying a user at said image and information management system workstation.

16. The method of claim 11, further comprising terminating said remote control of said at least a portion of functionality at said image and information management system workstation.

17. The method of claim 11, further comprising authenticating access to said image and information management system workstation for remote control of said image and information management system workstation.

18. A computer-readable storage medium including a set of instructions for a computer, said set of instructions comprising:
a control initiator routine for initiating a conference request with a workstation;
a response routine for at least one of accepting and denying the conference request; and
a remote control routine for remotely controlling functionality of the workstation after acceptance of the conference request,
wherein said remote control routine accommodates a display protocol at the workstation.

19. The set of instructions of claim 18, wherein said remote control routine transmits at least one of an image and information for display at the workstation.

20. The set of instructions of claim 18, wherein said remote control routine is capable of remotely configuring a display protocol of the workstation to share diagnostic quality images.
